(19) United States
(12) Patent Application Publication
(10) Pub. No.: US 2015/0039438 A1
(43) Pub. Date: Feb. 5, 2015

(54) METHOD AND APPARATUS FOR PROVIDING RECALL NOTIFICATIONS TO CUSTOMERS

(71) Applicant: Motorola Solutions, Inc, Schaumburg, IL (US)

(72) Inventors: MICHAEL F KORUS, Eden Prairie, MN (US); STEVEN L. ZIMMERMAN, Minnetonka, MN (US)

(73) Assignee: Motorola Solutions, Inc, Schaumburg, IL (US)

(21) Appl. No.: 13/954,150

(22) Filed: Jul. 30, 2013

(51) Int. Cl. G06Q 30/00

(52) U.S. Cl. CPC G06Q 30/014
USPC 705/14.64; 705/303; 705/26.8

(57) ABSTRACT

A method and apparatus for providing targeted recall notifications are provided herein. During operation the system will determine a probability of a customer actually having purchased a recalled product. A notification of the recall will then be sent to the customer based on this probability, even if no direct evidence exists that the customer actually purchased the product. Because recall notifications will be provided to customers based on their probability of purchasing a recalled product, customers will be more likely to receive a recall notification on a product that they purchased.

### FIELD OF THE INVENTION

The present invention generally relates to recall notifications, and more particularly to providing targeted recall notifications to customers.

### BACKGROUND OF THE INVENTION

Many stores, track customer purchases in order to keep a database of the buying habits of their customers. This is usually accomplished by offering “rewards cards” to their customers to increase customer loyalty. These reward cards (i.e. loyalty cards, club cards, preferred customer cards, etc.) provide the customer with discounts or points for a future purchases in return for personal information. Retailers use the personal information to track purchasing habits of their customers. A backend database is used for tracking customer purchases along with analytics software to determine more efficient marketing campaigns and advertising opportunities.

Prior-art systems have been designed to provide targeted advertisements to customers based on their shopping habits. Included in the advertisements provided to customers is the notification of recalled products that were purchased by the customer. For example, US Pub. No. 2002/0174025, entitled METHOD AND SYSTEM FOR PROVIDING TARGETED ADVERTISING AND PERSONALIZED CUSTOMER SERVICES, (incorporated by reference herein) provides for a system that notifies customers if they have purchased recalled products. As indicated in the '025 publication, if a customer has purchased a product that was then recalled, the system displays a targeted messages to the customer on a handheld device.

While the above-described technique is helpful in reducing use of recalled products, a problem exists in that prior-art systems only provide the recall warning to the customer if it has been determined that the customer actually purchased the product. Thus, for example, if the product was purchased at store A, and store B has no indication of this fact, then store B will fail to provide the recall notice to the customer. As is evident, this may be problematic in that the customer must visit store A to be provided with the recall notice. Therefore a need exists for a method and apparatus for providing targeted recall notifications to customers that increases the chances that a customer will receive a needed recall notice even if the customer did not purchase the product from the store providing the recall notification.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general operational environment, according to one embodiment of the present invention;

FIG. 2 is a block diagram of a system for providing targeted advertising and personalized customer services using a wireless communication device according to a second embodiment of the present invention.

FIG. 3 is a flow chart showing operation of the systems of FIG. 1 and FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for providing targeted recall notifications are provided herein. During operation the system will determine a probability of a customer actually having purchased a recalled product. A notification of the recall will then be sent to the customer based on this probability, even if no evidence exists that the customer actually purchased the product. Because recall notifications will be provided to customers based on their probability of purchasing a recalled product, customers will be more likely to receive a recall notification on a product that they purchased.

For example, assume that a consumer is a loyalty customer at Store A but not at Store B. Assume that there is a buying history of purchasing hams for the Easter holiday at Store A, but this year the ham is purchased at Store B. If a ham recall is issued, the customer would not get the advisory from Store B since they are not a registered loyalty customer. Since Store A and Store B will both get the recall notice, and there is a ham buying history at Store A, the consumer will still be provided the recall product advisory by Store A.

In a preferred embodiment, the recall notice is provided to the customer when the customer enters the premises of Store A, however, one of ordinary skill in the art will recognize that in alternate embodiments any means (e.g., email, text message, a phone call, mail, . . . , etc.) for providing the recall notice to the customer may be utilized.

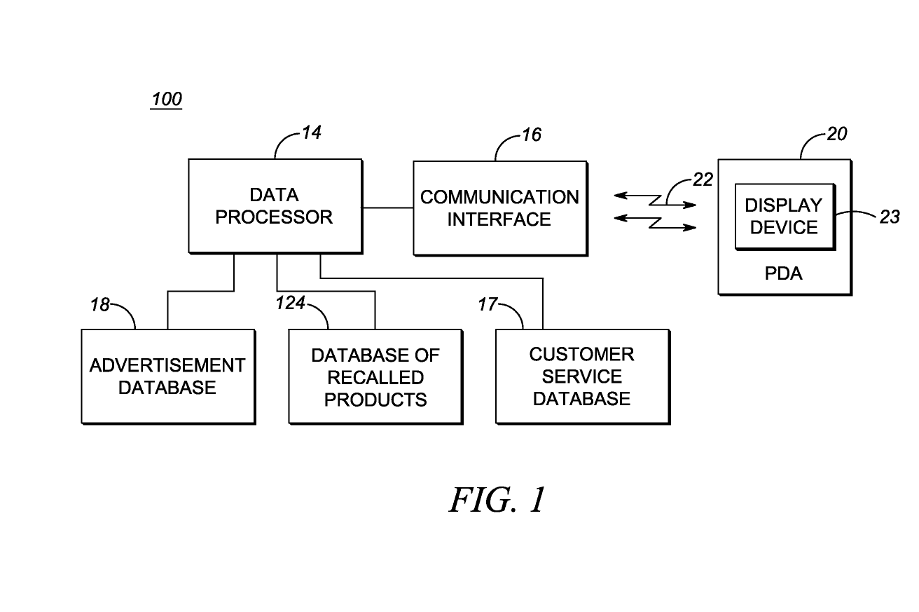

FIG. 1 is a block diagram of a system 100 for providing targeted advertising and personalized customer services using a wireless communication device. The system is preferably similar to the system described in the '025 publication discussed above. The system 100 can be implemented in or for a store, shopping mall, or other shopping area or environment. As shown in FIG. 1, the system 100 includes a data processor 14 (e.g., a microprocessor), a communication interface 16, a customer service database 17, an advertisement database 18, and at least one customer interface 20. Customer interface 20 may comprise a personal-digital assistant (PDA) 20 carried by a user such as a customer, or may simply comprise a customer's smartphone running an appropriate application, and serving as customer interface 20 to system 100. In alternate embodiments of the present invention interface 20 may comprise devices using other means of communications such as, but not limited to voice-mail, email, text, messaging, etc. Regardless of the form customer interface 20 takes, interface 20 will comprise a graphical user interface 23 that provides recall information to the user, and will be described below in system 100 as a user's smartphone.

The smartphone 20 is a conventional smartphone capable of short-range wireless communication 22 with the communication interface 16 according to known communication techniques such as infrared communication or “Bluetooth” techniques.

To provide short-range wireless communication 22 between the smartphone 20 and the communication interface 16, e.g., using Bluetooth techniques, each of the smartphone 20 and the communication interface 16 includes therein a Bluetooth radio unit known in the art.

When the smartphone 20 carried by the customer is present within a predetermined communication range of the communication interface 16 and the smartphone 20 is in a state where communication is enabled, the communication interface 16 initiates communication with the smartphone 20 through the Bluetooth radio units according to Bluetooth techniques, and is able to access automatically certain information or files stored in the smartphone 20, such as shopping list files, to-do list information, purchase history, product preferences, etc. One or any combination of this information is referred to herein as “preference information” identifying products, brands, stores, language, color, currency, size, or any other item preferred by the customer. This information is added to customer service database 17, which may added/appended to past customer-preference information.

The communication interface 16 transmits the preference information collected from the customer's smartphone 20 to the data processor 14. The data processor 14 then processes the preference information and utilizes this information and previously collected preference information to select appropriate advertisements for the customer.

To select appropriate advertisements that would be likely to interest the customer, i.e., to provide targeted advertising to the customer, the data processor 14 correlates the past and present preference information with a list of advertisements that are available in advertisement database 18 and is configured to select appropriate advertisement(s) based on the correlation results according to certain criteria. The advertisements can be stored in the advertisement database 18 or any other location accessible by the data processor 14. The selected advertisements are communicated to the customer's smartphone 20 via the short-range wireless communication 22, and displayed on display device 23 such as a screen on the smartphone 20. Different targeted advertisements may be displayed on the display device 23 as the customer roams around the store or appropriate shopping area.

In one embodiment of the present invention an advertisement may comprise a “recalled product notification”. The recalled product notification will be provided to the user if it is determined by the data processor 14 that the user had a high probability of purchasing the recalled product. A database of recalled products 124 is maintained by the system of FIG. 1.

If the customer is in need of a particular customer service, the customer can request it using the smartphone 20. The smartphone 20 is provided with software which identifies a list of customer services offered by the system 100. Examples of customer services that can be offered by the system 100 include, but are not limited to, providing a particular location or store aisle number at which a particular product can be found, providing directions to a store, providing the location of a store if the system is implemented in a larger context such as a shopping mall, providing an automatic translation of product information or other information according to the customer's preferred language including Braille or audio for a vision-impaired customer, providing an automatic currency conversion of price according to the customer's preferred currency, providing sales and other promotional information for products, and other product information (e.g., availability, price, etc.), providing an estimate of order time for an out-of-stock item, providing a discount on an item to substitute for an out-of stock item, providing extended warranties, extended product specifications, application tips and/or configuration tips, providing a discount or targeted advertising for related or accessory items, etc. All of these customer services are provided based on the customer's preference information such as the customer's preferred products, brands, sizes, price range, color, stores, language, currency, etc., so that most appropriate and personalized customer services can be provided to the customer. Any information necessary to provide such customer services can be stored in the customer service database 17 or other location accessible by the data processor 14.

Once the customer selects his or her desired customer service and provides any additional information as needed, the smartphone 20 is configured to transmit this information to the communication interface 16 via the wireless communication 22. The communication interface 16 then transmits the same information to the data processor 14 which in turn processes the customer's request for the particular customer service. For example, if the customer has requested a price conversion service, then the data processor 14 may perform the monetary conversion calculations, or the data processor 14 may retrieve pre-calculated information stored in the customer service database 17. Then the data processor 14 provides the requested customer service by displaying the requested information on the display device 23 of the customer's smartphone 20 via the short-range wireless communication 22. For instance, the data processor 14 displays the price of the requested product in US dollars on the display device 23.

Accordingly, the present invention advantageously provides targeted advertising and recall notifications using the smartphone or other communication device registered by the customer based on the customer's preference information.

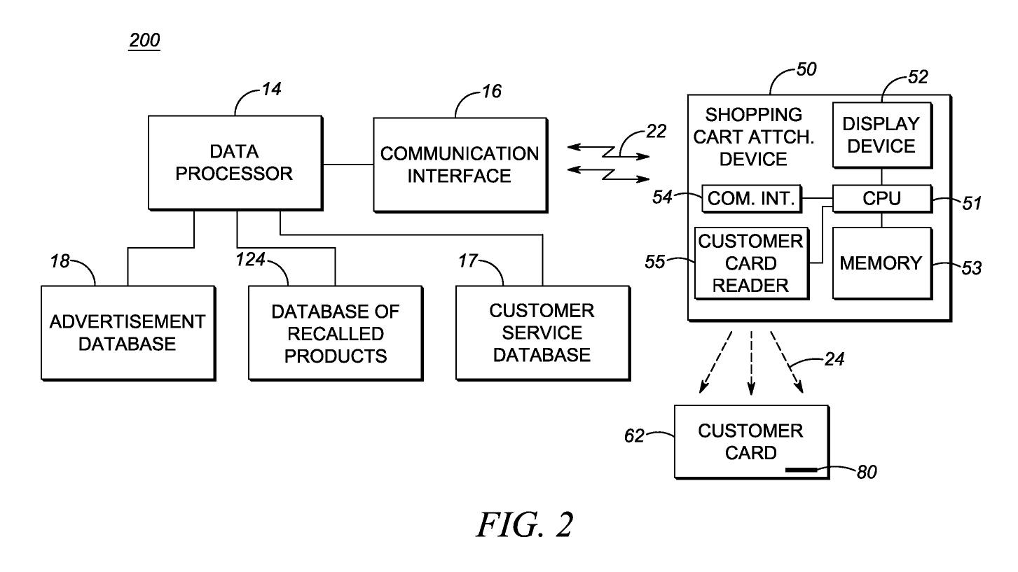

FIG. 2 is a block diagram of a system 200 for providing targeted advertising and personalized customer services using a wireless communication device according to a second embodiment of the present invention. As shown in FIG. 2, the system 200 includes a data processor 14, a communication interface 16, a customer service database 17, an advertisement database 18, and a shopping cart attachment device 50, all operatively coupled. In this embodiment, in lieu of the customer's smartphone 20 (FIG. 1), the communication interface 16 communicates with the shopping cart attachment device 50.

The shopping cart attachment device 50 is preferably installed on a conventional shopping cart that customers use during their shopping. The shopping cart attachment device 50 includes a CPU (Central Processing Unit) 51, a display device 52, memory 53, a communication interface 54, and a customer card reader 55, all operatively coupled. The communication interface 54 is configured to perform short-range wireless communication 22 with the communication interface 16 using known communication techniques such as infrared or Bluetooth communication techniques, a combination of Bluetooth and wireless or wired LAN, etc.

The customer card reader 55 is a conventional card reader for reading a customer card 62 such as a membership card, a credit card, a debit card, a customer ID card. The customer card 62 includes a storage unit 80 for storing the customer's personal information, preference information, etc. The storage unit 80 can be in the form of an optical medium, a magnetic stripe, a chip, a RFID (Radio Frequency Identification) tag, a hologram, etc. Depending on the type of the storage unit 80, the type of the customer card reader 55 will vary. For example, if the storage unit 80 of the customer card 62 is a RFID tag, the customer card reader 55 will be a RFID tag reader for scanning radio signals from the RFID tag wirelessly. If the storage unit 80 of the customer card 62 is a semiconductor chip, then the customer card reader 55 is a smart card reader for reading the chip when the customer card 62 is inserted into the card reader 55. All these storage units and card readers are well known in the art. If the storage unit 80 is a RFID tag, the customer's preference information pre-stored in the RFID tag of the customer card 62 can be updated on a regular basis by rewriting wirelessly the information stored in the RFID tag according to known RFID tag techniques as the customer's preference changes. In addition, the storage unit 80 can be configured to store therein the demographic information about the owner of the card 62. The demographic information can supplement the preference information to provide more targeted advertising and more personalized customer services.

The above-described system provides recall notifications to devices based on the likelihood of the recalled product being purchased by the user of the device. There may be many differing techniques to determine the likelihood of the recalled product being purchased by the user. For example, a customer shopping list may be provided to the system without any corresponding customer ID. In this scenario, the shopping list may be analyzed to determine a probability of a recalled product being purchased. In another embodiment, when a customer ID is known, customer service database 17 is utilized to determine past purchases and the determination may be made based on past and/or present purchases. More particularly, data processor 14 will determine a customer's identification and access their customer-preference information from customer database 17. The customer-preference information may comprise information such as, but not limited to:
past products purchased by the user and their time/date of purchase;
current or past shopping lists;
inquiries made by the customer about certain products; and/or
whether or not location tracking reveals the consumer came in close proximity to the recalled product.

In the systems of FIG. 1 and FIG. 2 a database of recalled products 124 is coupled to data processor 14. This database preferably comprises information on recalled products. Such information includes, but is not limited to:
Product Brand;
Product Type;
Dates of Recall;
Product Lot Number; and/or
UPC number.

Data processor 14 (which may comprise a CPU, ASIC, Microprocessor, . . . , etc.) will analyze the customer-preference information (which may be past and/or present information) for the user along with the database of recalled products and determine a probability that the customer has purchased the recalled product. This probability may be determined via a number of differing ways. For example,
If an identified loyalty customer demonstrates a periodicity in purchases of a product which has been recalled, processor 14 may deduce a high probability that the loyalty customer purchased the product. Verification of an actual purchase of the recalled product can be accomplished by processor 14 communicating with customer service database 17. If the recalled product was not purchased but the periodicity information indicates a likelihood that it was purchased (e.g. at another retailer) the product recall information will be provided to the loyalty customer's registered communication devices (with a notification that the loyalty customer *may* have purchased the recalled product based on shopping habits).
If a recalled “brand” of product is contained within the customer's preference information (even if the recalled item was not actually purchased by the customer), processor 14 may deduce a high probability of the customer actually purchasing the product. For example, if it is determined that the customer prefers Acme Soap, and a recall was issued for Acme Soap produced between May and June, this recall information will be provided to device 20 or device 50, even if Acme Soap wasn't purchased by the customer at this store/chain during those time periods.
If processor 14 determines that a product has been purchased by the user that is similar to a recalled product, then processor 14 will assume a high probability that the user may have purchased the recalled product. For example, if processor 14 determines that customer service database 17 contains information that Brand X hamburger was purchased, and there is a recall advertisement for Brand Y hamburger, processor 14 may provide the recall notification to smartphone 20. Thus, the purchase of similar products may be used as an indication that a higher probability exists that the recalled product may have been purchased by the customer, and an appropriate warning may be provided to the customer.
If a customer remains unidentified (e.g. a loyalty card may not have been scanned), and processor 14 determines that a product has been included on the customer's shopping list that is similar to a recalled product, then processor 14 will assume a high probability that the user may have purchased the recalled product. For example, if processor 14 determines that customer's shopping list contains information that Brand X hamburger is desired, and there is a recall advertisement for Brand Y hamburger, processor 14 may provide the recall notification to smartphone 20. Thus, the identification of similar products may be used as an indication that a higher probability exists that the recalled product may have been purchased by the customer, and an appropriate warning may be provided to the customer.

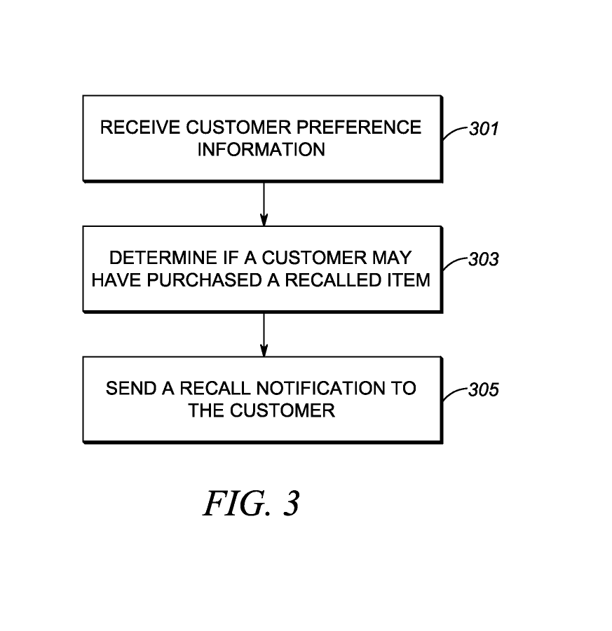

FIG. 3 is a flow chart showing operation of the systems of FIG. 1 and FIG. 2. The logic flow begins at step 301 where communications interface 16 receives customer-preference information. This information may come from an electronic shopping list from a device carried by the customer, or may simply come from database 17. Database 17 contains information such as, but not limited to which past items preferred by the customer, past products purchased by the customer and their time/date of purchase, products contained in the customer's current or past shopping lists, and/or products contained in inquiries made by the customer.

At step 303 processor 14 then determines if a customer may have purchased a recalled item. As discussed above, this determination may be made based on both past and present customer-preference information. Additionally, this step may comprise determining a probability, or likelihood that the customer may have purchased the recalled item. In various embodiments, step 303 comprises one, or a combination of the following:
analyzing a database containing present and past customer-preference information to determine if an identified loyalty customer demonstrates a periodicity in purchases of a product which has been recalled;
determining that a product has been purchased by the user that is similar, but not identical, to a recalled product;
determining if a recalled “brand” of product is contained within the customer-preference information; and/or
determining if a product has been included on an unidentified customer's shopping list that is similar to a recalled product.

Finally, at step 305 a recall notification is sent to the customer when the customer may have purchased the item. For example, if the probability that the customer has purchased the item is above a predetermined threshold, the recall notification is sent to the customer. The recall notification may be provided by:
wirelessly transmitting an advertisement to a customer;
wirelessly transmitting an advertisement to a customer's smartphone; and/or
sending an email, mail, and/or a text message to the customer.

In the foregoing specification, specific embodiments have been described. However, one of ordinary skill in the art appreciates that various modifications and changes can be made without departing from the scope of the invention as set forth in the claims below. For example, data processor 14 may execute routine queries of database 124 in search of newly recalled products. Data processor 14 may then search customer service database 17 for loyalty customers that may have purchased the recalled product by performing analytics on the customer's past shopping habits, without the customer having to be in the store. If processor 14 determines that a product may have been purchased by a loyalty customer the loyalty customer is informed by any communication means available in communications interface 16 (e.g., email, text message, landline phone call, mail, wireless/cell phone call . . . , etc.) using loyalty customer provided contact information.

Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for providing recall notifications to a customer, the method comprising the steps of:
receiving customer-preference information via a communications interface;
based on the customer-preference information, determining that the customer may have purchased a recalled item; and
providing a recall notification to the customer when the customer may have purchased the recalled item.

2. The method of claim 1 wherein the step of receiving the customer-preference information comprises the step of receiving an electronic shopping list from a device carried by the customer.

3. The method of claim 1 further comprising the step of:
additionally receiving customer-preference information via a database containing customer-preference information.

4. The method of claim 3 wherein the database containing customer-preference information comprises:
past products purchased by the customer and their time/date of purchase;
products contained in the customer's current or past shopping lists; and/or
products contained in inquiries made by the customer.

5. The method of claim 4 wherein the step of determining that the customer may have purchased the recalled item comprises the step of analyzing the database containing present and past customer-preference information to determine if an identified loyalty customer demonstrates a periodicity in purchases of the recalled item.

6. The method of claim 3 wherein the step of determining that the customer may have purchased the recalled item comprises the step of determining that a product has been purchased by the user that is similar to the recalled item.

7. The method of claim 1 wherein the step of determining that the customer may have purchased the recalled item comprises the step of determining if a recalled “brand” of product is contained within the customer-preference information.

8. The method of claim 1 wherein the step of determining that the customer may have purchased the recalled item comprises the step determining if the item has been included on an unidentified customer's shopping list, and that the item is similar, but not identical to a recalled product.

9. The method of claim 1 wherein the step of providing the recall notification to the customer comprises the step of wirelessly transmitting an advertisement to a customer's smartphone.

10. The method of claim 1 wherein the step of providing the recall notification to the customer comprises the step of wirelessly transmitting an advertisement to the customer.

11. The method of claim 1 wherein the step of providing the recall notification to the customer comprises the step of sending an email, mail, and/or a text message to the customer.

12. A method for providing recall notifications to a customer, the method comprising the steps of:
receiving customer-preference information from the customer via a communications interface;
determining additional customer-preference information about the customer by accessing a database containing past customer-preference information;
based on the customer-preference information received from the customer, and the customer-preference information accessed from the database, determining that the customer may have purchased a recalled item; and
wirelessly providing a recall notification to the customer when the customer may have purchased the recalled item.

13. An apparatus for providing recall notifications to a customer, the apparatus comprising:
a communications interface receiving customer-preference information;
a processor determining that the customer may have purchased a recalled item based on the customer-preference information; and
the communications interface providing a recall notification to the customer when the customer may have purchased the recalled item.

14. The apparatus of claim 12 wherein the customer-preference information comprises an electronic shopping list from a device carried by the customer.

15. The apparatus of claim 12 wherein the customer-preference information comprises information contained within a database.
